(19) United States
(12) Patent Application Publication
(10) Pub. No.: US 2006/0230133 A1
(43) Pub. Date: Oct. 12, 2006

(54) On demand problem determination based on remote autonomic modification of web application server operating characteristics

(75) Inventors: Scott Howard Snyder, Chapel Hill, NC (US); William Gail Stoddard, Cary, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/089,755

(22) Filed: Mar. 24, 2005

(51) Int. Cl. G06F 15/173

(52) U.S. Cl. 709/224

(57) ABSTRACT

A method, system and computer program product for selectively collecting problem determination data. In a preferred embodiment, the method begins when a request for an application server is received from a user. Once it is determined that the request should have triggers added, triggers are added. This modified request is transmitted to the application server. The application server transmits a response back to the Web server containing the desired problem determination data. The Web server removes the problem determination data from the response and transmits this modified response to the user.

### BACKGROUND OF THE INVENTION

1. Technical Field

The present invention relates generally to distributed data processing systems. Specifically, the present invention relates to a method, system and computer program product for selectively collecting problem determination data from a remote server and transferring that data to another machine for analysis.

2. Description of Related Art

Modern computing technology has resulted in immensely complicated and ever-changing environments. One such environment is the Internet, which is also referred to as an “internetwork.” The Internet is a set of computer networks, possibly dissimilar, joined together by means of gateways that handle data transfer and the conversion of messages from a protocol of the sending network to a protocol used by the receiving network. When capitalized, the term “internet” refers to a collection of networks and gateways that use the TCP/IP suite of protocols. Currently, the most commonly employed method of transferring data over the Internet is to employ the World Wide Web environment, also called the “Web”. Other internet resources exist for transferring information, such as File Transfer Protocol (FTP) and Gopher, but have not achieved the popularity of the Web. In the Web environment, servers and clients effect data transactions using the Hypertext Transfer Protocol (HTTP), a known protocol for handling the transfer of various data files such as text, still graphic images, audio, motion video, etc. HTTP is made up of header information and content. HTTP allows for the creation of custom headers. The information in various data files is formatted for presentation to a user by a standard page description language, the Hypertext Markup Language (HTML). The Internet also is used widely to transfer applications to users using browsers. Often times, users may search for and obtain software packages through the Internet.

Other types of complex network data processing systems include those created for facilitating work in large corporations. In many cases, these networks may span across regions in various worldwide locations. These complex networks also may use the Internet as part of a virtual product network for conducting business. These networks are further complicated by the need to collect and analyze data concerning software application errors that occur within the network.

Often, software applications exhibit problems that only occur in a specific customer environment. This makes duplication of the problem in a controlled environment difficult if not impossible until the nature of the problem is determined. Unfortunately, the information necessary to isolate the exact nature of the problem can be difficult to obtain because enabling logging and/or trace information can significantly modify the runtime behavior of the system.

In this situation, the additional overhead and modified runtime execution path of the logging and trace infrastructure can prevent the problem from reoccurring, or cause additional problems to arise that are not relevant to resolving the outstanding problem. This makes it even more costly, time consuming and difficult to fix the problem.

Therefore, it would be advantageous to have an improved method, system and computer program product to selectively collect problem determination (PD) data from a malfunctioning machine and transfer this data to another machine for analysis.

### BRIEF SUMMARY OF THE INVENTION

The present invention provides a method, system and computer program product for selectively collecting problem determination data. In a preferred embodiment, the method begins when a request for an application server is received from a user. Once it is determined that the request should have triggers added, triggers are added to the request to form a modified request. This modified request is transmitted to the application server. The application server transmits a modified response back to the Web server containing the desired problem determination data. The Web server removes the problem determination data from the modified response and transmits the unmodified response to the user.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented in accordance with a preferred embodiment of the present invention.

FIG. 2 is a block diagram of a data processing system in accordance with a preferred embodiment of the present invention.

FIG. 3 is a block diagram illustrating a data processing system in which the present invention may be implemented.

FIG. 4 is a block diagram illustrating data flow of a network of data processing system in accordance with a preferred embodiment of the invention.

FIG. 5 is a flowchart that illustrates a method for adding triggers in accordance with a preferred embodiment of the present invention.

### DETAILED DESCRIPTION OF THE INVENTION

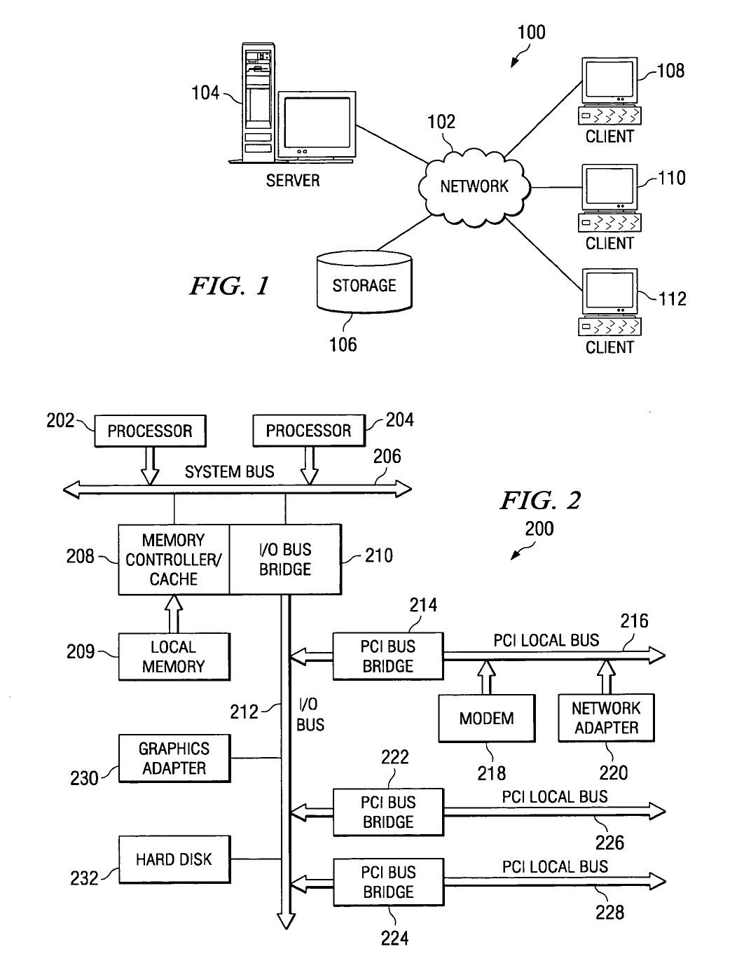

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

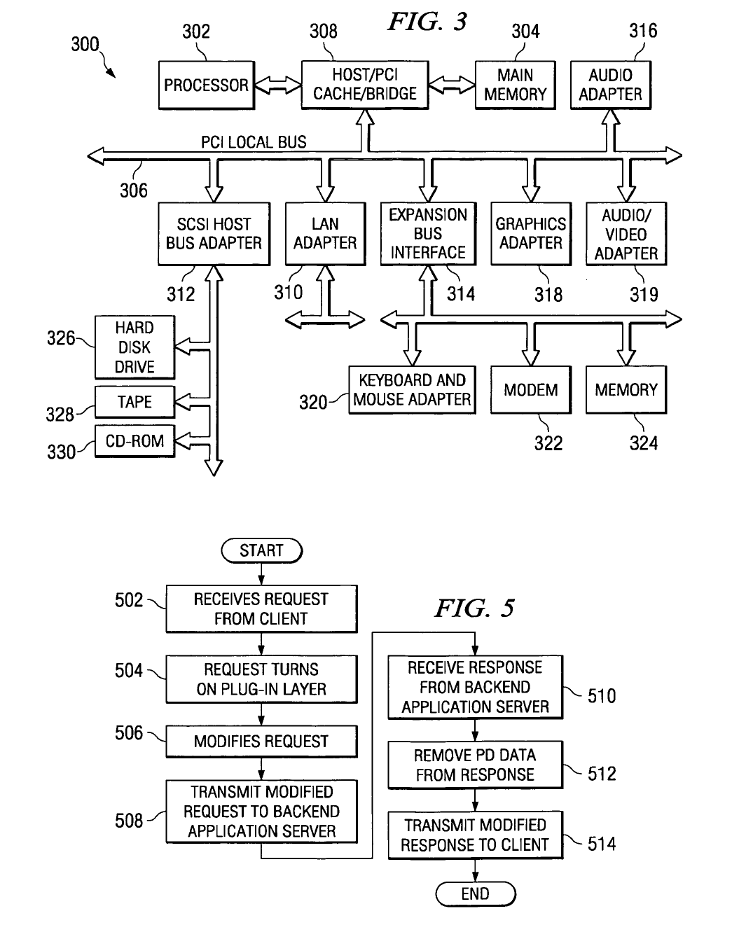

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method, system and computer program product for selectively collecting problem determination data. In a preferred embodiment, the method begins when a request for an application server is received from a user. Once it is determined that the request should have triggers added, triggers are added to the request to form a modified request. This modified request is transmitted to the application server. The application server transmits a modified response back to the Web server containing the desired problem determination data. The Web server removes the problem determination data from the modified response and transmits the unmodified response to the user.

By collecting the PD data in this manner, the problem of having to duplicate the runtime environment in which the problem occurred is avoided. Also, as the present invention does not enable logging and tracing, the runtime behavior of the system is not altered, making it easier to determine the true nature of the problem. Additionally, the present invention, by having the application server gather the PD data, avoids the problem of additional, extraneous problems arising due to the modified execution path caused by logging and tracing.

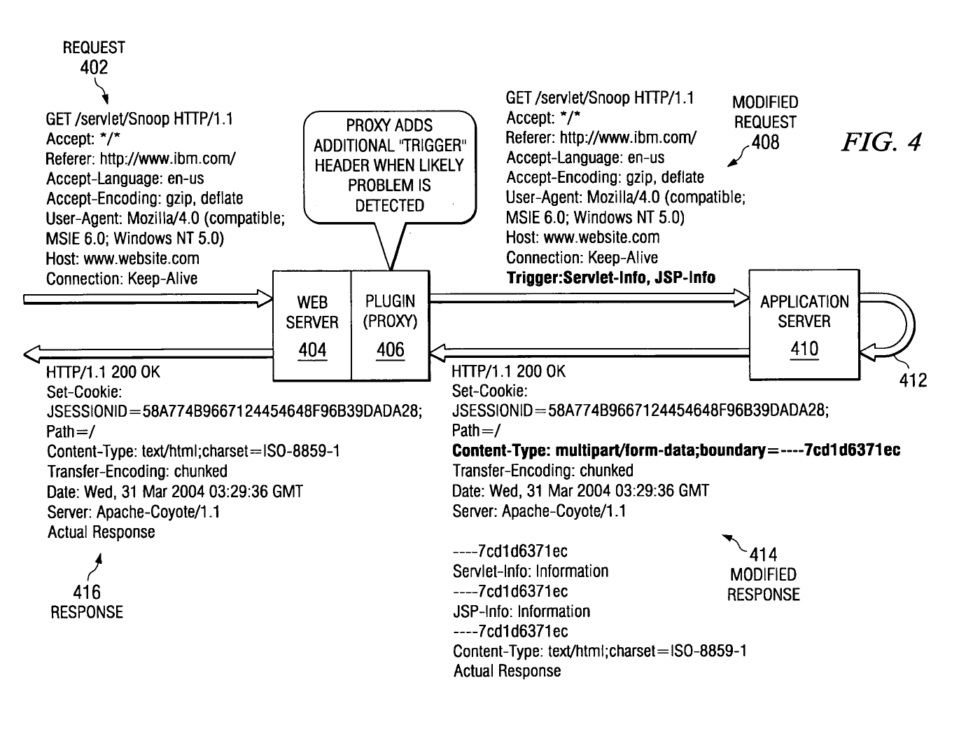

With reference now to FIG. 4, a block diagram illustrating the data flow of a network of data processing systems in accordance with a preferred embodiment of the invention. The data flow begins when a client, which can be implemented as a data processing system, such as data processing system 300 in FIG. 3 sends request 402 to Web server 404 to be routed to application server 410. Request 402 is and example of a generic HTTP protocol request. Request 402 turns on plug-in layer (proxy) 406 of Web server 404. Proxy 406 adds one or more triggers to the request which will cause application server 410 to gather the appropriate PD data.

In a preferred embodiment, proxy 406 is configured to add the appropriate triggers to gather the PD data for the problem by a user. That is, once a problem is detected or suspected to be occurring in an application server, a user, such as the system administrator, configures proxy 406 to add the triggers necessary to gather the desired information to browser requests. Proxy 406 can be configured so that only certain requests received by Web server 404 turn on proxy 406.

In another embodiment, proxy 406 may have the capability to detect suspicious behavior by application server 410. In such a case, proxy 406 may add the appropriate triggers to requests destined for application server 410. Upon receiving the PD data, proxy 406 would then notify an appropriate user, such as the system administrator that the data was available for analysis.

In a further embodiment, proxy 406 may be equipped with the software to perform anomaly detection and PD data analysis. Currently no specific software exists to do this, but some existing software packages, such as IBM Tivoli software, could be modified to perform this task._In such a case, proxy 406 may add the appropriate triggers to requests destined for application server 410. Upon receiving the PD data, proxy 406 would then analyze the gathered PD data and send its conclusions to an appropriate user, such as the system administrator. Alternately, in a fully autonomic system, proxy 406 would then begin procedures to fix the problem based on its conclusions.

Triggers are piggybacked as meta-data on the underlying protocol of the request. In the case of HTTP protocol, the trigger is one or more special purpose HTTP header fields. These special purpose HTTP header fields are custom created fields. Therefore, not only must proxy 406 be programmed to insert these custom fields, but the application server 410 must be able to understand the custom fields as well. Triggers that application server 410 may not be aware of, or not know how to handle, can be added through Aspect Oriented Programming. Application server 410 is also programmed, using Aspect Oriented Programming, to understand the custom fields as well.

The type of trigger tells application server 410 what PD data to collect. Some examples of PD data include, but are not limited to, method/class flows, method timings, database connection pools, session information, number and type of applications executed, etc.

Modified request 408 is then transmitted to application server 410. Modified request 408 is an example of how a HTTP header might appear once a trigger has been added by proxy 406. In the current example, the trigger that has been added to HTTP header is “Trigger:Servlet-Info,JSP-info”. Application server 410 receives the modified request, decodes the special purpose HTTP header fields and begins collecting PD data, as instructed by the triggers, as indicated by arrow 412. Triggers can be set based on any arbitrary configurable event. Some examples of an arbitrary configurable event include, but are not limited to, per-URL, every nth request of a specific resource, when the time to serve a URL falls out of a QOS criterion, requests from certain IP addresses, on requests to certain backend servers, when a failure is detected on one or more backend servers, when the client requests the PD to be collected, requests to certain urls at certain times, etc.

Aspect Oriented Programming techniques are used to program application server 410 so that application server 410 can identify and understand triggers contained in modified request 408. The trigger specifies, directly or indirectly, that a particular aspect of a component be run in the application server when servicing the request. Different aspects can be created to produce arbitrarily “rich” responses to collect any manner of PD data needed, such as path flow traces, system resource utilization, downstream performance characteristics, cluster work load distribution, network latency, etc. Literally anything that can be instrumented and collected can be implemented in an aspect of a component and reported back to the server that set the trigger. A componentized application server has the ability to dynamically load “containers” on demand, such as to run a JavaServer Pages, a Servlet, a Portlet, Hypertext Preprocessor (PHP) application, etc., and can load different aspects of each of these containers depending on the trigger that was received. Each aspect will provide a different set of PD data piggy backed on the client response.

Once application server 410 has collected the PD data, application server 410 modifies the response to Web server 404 to form a modified response, such as modified response 414. In modified response 414, the response header for the collected PD data is shown as “Content-type: multipart/form-data; boundary=----7cdld6371ec”.

Modified response 414 is then streamed back to Web server 404. PD data can piggybacked on modified response 414 via multipart MIME (RFC 2046) or WebServices SOAP messaging, depending upon the nature of the response. Proxy 406 collects the returned PD data, removing it from response 416. Response 416 is then transmitted to the client. Thus, the client is never even aware of the PD data gathering process. Proxy 406 aggregates and organizes the removed PD data sets. Proxy 406 then transmits this PD data to the appropriate user for analysis.

It is important to note that while in the process described above client and proxy 406 are presented as separate components, client and proxy 406 could be a single component. Therefore, the process would be started by Web server 404, which would then modify its own request through the use of proxy 406.

While the above described process has been described in terms of use with a single application server, the above described process is applicable for use in system with multiple application servers. A single Web server 404 could transfer modified requests to multiple application servers and gather data from multiple application servers. Additionally, the above described process is applicable to systems with webservices tiers in place of or in addition to application servers.

In another embodiment, rather than passing on the gathered PD data, proxy 406 could analyze the data as well as collect it.

While the above described process has been described in terms of using HTTP protocol as the communication protocol, any other protocol, such as WebServices, XML and IIOP, for example, could be used in place of the HTTP protocol or in addition to the HTTP protocol, depending on the implementation. For example, in the case XML, the triggers could be added directly into the XML file itself.

FIG. 5 is a flowchart that illustrates a method for adding triggers in accordance with a preferred embodiment of the present invention. The method begins when a Web server, such as Web server 404 in FIG. 4, receives a request to be routed to an application server or webservices tier that is experiencing problems or is anticipated to soon be experiencing problems (step 502). The Web server could receive the request from an external source or the request could be generated internally.

The request turns on a proxy, like proxy 406 in FIG. 4, of the Web server (step 504). The proxy modifies the request by adding triggers to the request (step 506).

Triggers are piggybacked as meta-data on the underlying protocol of the request. In the case of HTTP protocol, the trigger is one or more special purpose HTTP header fields. These triggers will cause the application server or webservices tier to collect appropriate PD data and transmit it back to the Web server.

The proxy transmits the modified request to the application server or webservices tier (step 508). Once the Web server receives a response from the application server (step 510), the proxy removes the PD data from the response (step 512). The proxy then transmits the modified response to the client (step 514) and the method ends.

While the above described process has been described in terms of use with a single application server or webservices tier, the above described method is applicable for use with multiple application servers or webservices tiers or a combination thereof.

Furthermore, while the above described process has been described in terms of using HTTP protocol as the communication protocol, any other protocol, such as WebServices, XML and IIOP, for example, could be used in place of the HTTP protocol or in addition to the HTTP protocol, depending on the implementation. For example, in the case XML, the triggers could be added directly into the XML file itself.

Thus the present invention solves the disadvantages of the prior art by providing a method, system and computer program product for to selectively collect problem determination data. In a preferred embodiment, the method begins when a request for an application server is received from a user. Once it is determined that the request should have triggers added, triggers are added. This modified request is transmitted to the application server. The application server transmits a modified response back to the Web server containing the desired problem determination data. The Web server removes the problem determination data from the modified response and transmits the unmodified response to the user.

By collecting the PD data in this manner, the problem of having to duplicate the runtime environment in which the problem occurred is avoided. Also, as the present invention does not enable logging and tracing, the runtime behavior of the system is not altered, making it easier to determine the true nature of the problem. Additionally, the present invention, by having the application server gather the PD data, avoids the problem of additional, extraneous problems arising due to the modified execution path caused by logging and tracing.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for selectively collecting problem determination data, the method comprising:
receiving a request from a user to be transmitted to an application server;
responsive to a determination that the request requires a trigger, adding the trigger to the request to form a modified request, wherein the trigger has a type that tells the application server what problem determination data to collect and wherein the trigger is piggybacked as meta-data on an underlying protocol of the request;
transmitting the modified request to the application server;
receiving a modified response from the application server containing problem determination data; and
processing the problem determination data.

2. The method of claim 1 wherein the step of processing the problem determination data is further comprised of:
removing the problem determination data from the modified response to form a normal response; and
transmitting the normal response to the user that issued the request.

3. The method of claim 1, wherein the modified request is transmitted to multiple application servers.

4. The method of claim 1, wherein the application server is a webservices tier.

5. The method of claim 1, wherein adding the trigger to the request to form a modified request comprises:
programming a proxy to selectively add triggers to requests destined for an application server, wherein the proxy sits between the user and the application server.

6. The method of claim 5, wherein the proxy automatically programs itself.

7. The method of claim 1, wherein the user is a Web server.

8. The method of claim 1, wherein the underlying protocol is and HTTP protocol.

9. The method of claim 5, wherein the processing of the problem determination data is performed by the proxy.

10. A computer program product in a computer readable medium for selectively collecting problem determination data, comprising:
first instructions for receiving a request from a user to be transmitted to an application server;
second instructions, responsive to a determination that the request requires a trigger, for adding the trigger to the request to form a modified request, wherein the trigger has a type that tells the application server what problem determination data to collect and wherein the trigger is piggybacked as meta-data on an underlying protocol of the request;
third instructions for transmitting the modified request to the application server;
fourth instructions for receiving a modified response from the application server containing problem determination data; and
fifth instructions for processing the problem determination data.

11. The computer program product of claim 10, wherein the modified request is transmitted to multiple application servers.

12. The computer program product of claim 10, wherein the application server is a webservices tier.

13. The computer program product of claim 10, wherein the user is a Web server

14. The computer program product of claim 10, wherein adding the trigger to the request to form a modified request comprises:
sixth instructions for programming a proxy to selectively add triggers to requests destined for an application server, wherein the proxy sits between the user and the application server.

15. The computer program product of claim 14, wherein the proxy automatically programs itself.

16. A data processing system for selectively collecting problem determination data, comprising:
receiving mechanism for receiving a request from a user to be transmitted to an application server;
adding mechanism, responsive to a determination that the request requires a trigger, for adding the trigger to the request to form a modified request, wherein the trigger has a type that tells the application server what problem determination data to collect and wherein the trigger is piggybacked as meta-data on an underlying protocol of the request;
transmitting mechanism for transmitting the modified request to the application server;
receiving mechanism for receiving a modified response from the application server containing problem determination data; and
processing mechanism for processing the problem determination data.

17. The data processing system of claim 16, wherein the modified request is transmitted to multiple application servers.

18. The data processing system of claim 16, wherein the application server is a webservices tier.

19. The data processing system of claim 16, wherein the user is a Web server

20. The data processing system of claim 16, wherein adding the trigger to the request to form a modified request comprises:
programming mechanism for programming a proxy to selectively add triggers to requests destined for an application server, wherein the proxy sits between the user and the application server.
